(19) United States
(12) Patent Application Publication
(10) Pub. No.: US 2022/0029853 A1
(43) Pub. Date: Jan. 27, 2022

(54) DATA FRAME STRUCTURE OF CAN COMMUNICATION MESSAGE FOR CONSTRUCTION MACHINERY AND METHOD OF TRANSMITTING CAN COMMUNICATION MESSAGE FOR CONSTRUCTION MACHINERY

(71) Applicant: Doosan Infracore Co., Ltd., Dong-gu (KR)

(72) Inventors: Seongho SONG, Dong-gu (KR); Wookhyun YU, Dong-gu (KR); Hansol KIM, Dong-gu (KR); Yoonhye KIM, Dong-gu (KR); Seokhwa JEONG, Dong-gu (KR)

(21) Appl. No.: 17/386,181

(22) Filed: Jul. 27, 2021

(30) Foreign Application Priority Data
Jul. 27, 2020 (KR) 10-2020-0093181

(51) Int. Cl. H04L 12/40

(52) U.S. Cl. CPC H04L 12/40071; H04L 2012/40215; H04L 12/40013; H04L 12/40143

(57) ABSTRACT

The present disclosure relates to a data frame structure of a Controller Area Network (CAN) communication message for construction machinery, which is capable of generating a large number of setting items, and a method of transmitting a CAN communication message for construction machinery, and the data frame structure includes: an identifier including a parameter group number PGN having a destination address; and a data field including a suspect parameter number SPN related to the parameter group number PGN and parameter data related to the suspect parameter number SPN.

### CROSS-REFERENCE TO RELATED APPLICATIONS

This application claims benefit and priority to Korean Patent Application No. 10-2020-0093181, filed on Jul. 27, 2020, with the Korean Intellectual Property Office, the disclosure of which is incorporated herein in its entirety by reference.

### TECHNICAL FIELD

The present disclosure relates to a data frame structure of a Controller Area Network (CAN) communication message, and particularly, to a data frame structure of a CAN communication message for construction machinery, which is capable of generating a large number of setting items, and a method of transmitting a CAN communication message for construction machinery.

### BACKGROUND

As construction equipment becomes electronic, the number of nodes (electronic components or electronic control units) participating in Controller Area Network (CAN) communication is increasing, and accordingly, the setting items between the nodes using the CAN communication are rapidly increasing.

Korean Patent Application Laid-Open No. 10-2019-0006922, which is related to CAN communication, discloses a method of increasing data throughput in CAN communication.

### SUMMARY

The present disclosure has been made in an effort to provide a data frame structure of a Controller Area Network (CAN) communication message for construction machinery, which is capable of generating a large number of setting items, and a method of transmitting a CAN communication message for construction machinery.

An exemplary embodiment of the present disclosure provides a data frame structure of a Controller Area Network (CAN) communication message for construction machinery, the data frame structure including: an identifier including a parameter group number PGN having a destination address; and a data field 400 including a suspect parameter number SPN related to the parameter group number PGN and parameter data related to the suspect parameter number SPN.

The data field 400 further includes a reservation bit.

The suspect parameter number SPN has a size of 19 bits.

The suspect parameter number SPN is defined by 8192 usable data among 219 data.

The usable data is the data having a value of 516096 to data having a value of 524287.

The parameter group number PGN includes: a PDU specific field PS defining the destination address; and a PDU format field PF having a data value in a predetermined range so that the PDU specific field PS has a destination address.

The identifier further includes a transmission source address corresponding to the destination address.

Another exemplary embodiment of the present disclosure provides a method of transmitting a data frame of a Controller Area Network (CAN) communication message for construction machinery, the method including: generating a setting event for setting a parameter for a specific setting item to a specific value; transmitting, by a transmitting node, a command message related to the setting event, to a receiving node; and processing, by the receiving node, the setting event, in which the command message includes: an identifier including a parameter group number PGN having an address of the receiving node; and a data field 400 including a suspect parameter number SPN related to the parameter group number PGN and parameter data related to the suspect parameter number SPN.

The data frame structure of a CAN communication message for construction machinery and the method of transmitting a CAN communication message for construction machinery according to the present disclosure may provide the following effects.

First, it is possible to set a large number of setting items only with one parameter group number.

Second, it is possible to set a destination address, so that it is possible to set a setting item between various nodes.

Third, when setting of data is changed, an error generation probability may be remarkably reduced.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 is a diagram illustrating a data frame structure of a Controller Area Network (CAN) communication message for construction machinery according to an exemplary embodiment of the present disclosure.

FIG. 2 is a diagram illustrating one exemplary embodiment of a protocol data unit in a frame format of FIG. 1.

FIG. 3 is a diagram illustrating a content of a PDU format specific field according to a value of a PDU format field.

FIG. 4 is a diagram for describing an example of information included in a suspect parameter.

FIG. 5 is a diagram for describing a use example of a suspect parameter number and a parameter group number.

FIG. 6 is a diagram illustrating another exemplary embodiment of the protocol data unit in the frame format of FIG. 1.

FIG. 7 illustrates data included in a data field of FIG. 6.

FIG. 8 is a diagram for describing a method of transmitting a CAN communication message having a data frame structure of FIG. 6.

### DETAILED DESCRIPTION

In the following detailed description, reference is made to the accompanying drawing, which forms a part hereof. The illustrative embodiments described in the detailed description, drawing, and claims are not meant to be limiting. Other embodiments may be utilized, and other changes may be made, without departing from the spirit or scope of the subject matter presented here.

The advantages and characteristics of the present disclosure, and a method for achieving the advantages and characteristics will become clear by referring to the exemplary embodiment, which is described below in detail, together with the accompanying drawings. However, the present disclosure is not limited to exemplary embodiments disclosed herein but will be implemented in various forms, and the exemplary embodiments are provided so that the present disclosure is completely disclosed, and a person of ordinary skilled in the art can fully understand the scope of the present disclosure, and the present disclosure will be defined only by the scope of the appended claims. Accordingly, in several exemplary embodiments, well-known process steps, well-known element structures, and well-known technologies are not described in detail in order to avoid obscuring the present disclosure. Throughout the specification, the same reference numeral indicates the same constituent element.

In the drawings, the thickness of layers, films, panels, regions, etc., are exaggerated for clarity. Like reference numerals designate like elements throughout the specification.

In the present specification, terms, such as a first, a second, and a third, may be used for describing various constituent elements, but the constituent elements are not limited by the terms. The terms are used for discriminating one constituent element from other constituent elements. For example, without departing from the scope of the present disclosure, a first constituent element may be named as a second or third constituent element, and similarly, a second constituent element and a third constituent element may be alternately named.

Unless otherwise defined, all of the terms (including technical and scientific terms) used in the present specification may be used as a meaning commonly understandable by those skilled in the art. Further, terms defined in a generally used dictionary shall not be construed as being ideal or excessive in meaning unless they are clearly defined.

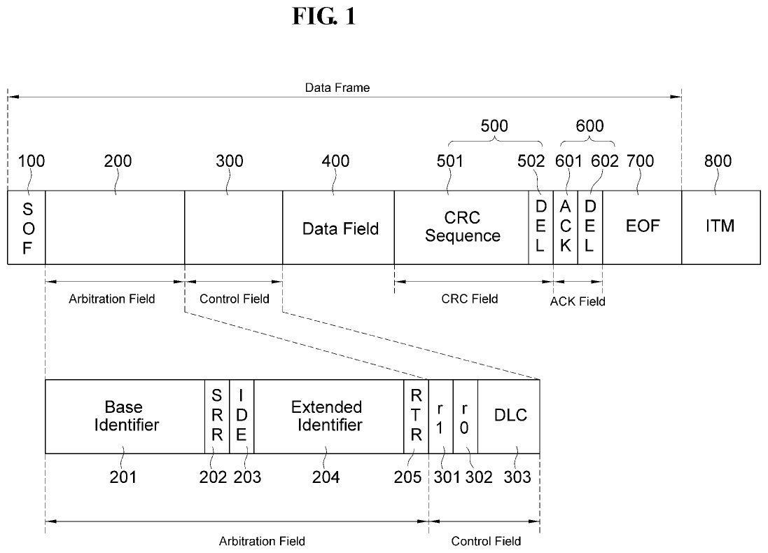

Hereinafter, a data frame structure of a Controller Area Network (CAN) communication message for construction machinery and a method of transmitting a CAN communication message for construction machinery according to the present disclosure will be described in detail with reference to FIGS. 1 to 8.

FIG. 1 is a diagram illustrating a data frame structure of a CAN communication message for construction machinery according to an exemplary embodiment of the present disclosure.

The CAN communication is a multi-master network, and uses a method of Carrier Sense Multiple Access/Collision Detection with Arbitration on Message Priority (CSMA/CD+AMP). The CAN communication system recognizes whether a bus line (for example, a CAN bus line) is being used before transmitting a message to a node (for example, an Electronic Control Unit (ECU)), and also performs a detection of a collision between messages. In this case, the message transmitted from a specific node does not include an address of a transmitter or a receiver. That is, the CAN communication is not performed by an addressing mode. Instead, at the beginning of the message, each node has a unique identifier (ID-11bits or 29bits) so as to identify each node in a CAN network.

After all of the nodes connected on the network receive a message on the network, only when the message is the message of a needed identifier, the node accepts the message, and otherwise, the node ignores the message. When data from multiple nodes flowing on the network (for example, a CAN communication line) flows to the node required by a user at the same time, the CAN communication system compares numbers of the identifiers and determines the priority of the message to be received first, and as the number of the identifier becomes lower, the priority becomes higher. The message with higher priority is guaranteed to use the bus line, and in this case, the message with lower priority is automatically retransmitted on the next bus cycle. Each message has an identifier (CAN 2.0A) of 11 bits or an identifier (CAN 2.0B) of 29 bits, and the identifier is located at the beginning of the message. The identifier serves to identify the type of message and to give priority to the message.

The CAN communication defines four frame types including a data frame, a remote frame, an error frame, and an overload frame.

The data frame is generally used in data transmission, and the remote frame is used when a receiving node requests transmission from a transmitting node that is capable of transmitting a message desired by the receiving node.

The error frame is used for the purpose of notifying a system of an error of a message when the error of the message is detected.

The overload frame is used for the purpose of synchronizing messages. In the CAN communication, the data transception is performed by using the message frame. The frame format of the CAN communication message may have a structure illustrated in FIG. 1.

A frame start field (SOF) consists of one dominant bit, indicates the beginning of the message, and is used for the purpose of synchronizing all of the nodes.

An arbitration field 200 may include a basic identifier 201 having a size of 11 bits, a Substitute Remote Request (SRR) bit 202 having a size of one bit, an Identifier Extension (IDE) bit 203 having a size of one bit, an extended identifier 204 having a size of 18 bits, and a Remote Transmission Request (RTR) bit 205 having a size of one bit. The arbitration field 200 is used for adjusting a collision between messages occurring when the messages are transmitted from two or more nodes at the same time. The value of the RTR bit 205 is used for determining whether the frame is a data frame (d) or a remote frame (r). Herein, the IDE bit 203 is disposed between the basic identifier 201 and the extended identifier 204 so that the basic identifier 201 and the extended identifier 204 may be distinguished from each other.

A control field 300 consists of a first reservation bit r1 having a size of 1 bit, a second reservation bit r0 having a size of 1 bit, and a Data Length Code (DLC) having a size of 4 bits.

A data field 400 may use up to 8 bytes, and is used for storing data (including data transmitted from a specific node to another node).

A CRC field 500 consists of a CRC sequence 501 of 15 bits generated by using a bit string from the frame start field SOF to the data field 400 and an CRC delimiter 502 of one “r” bit. The CRC field is used for examining whether there is an error in the message.

An ACK field 600 consists of an ACK slot 601 of one bit and one ACK delimiter 602. When a predetermined node receives a correct message, a value of the ACK slot 601 is set to “d” and the message is continuously transmitted on the bus at the moment of receiving the ACK field 600.

A frame end field 700 consists of seven “r” bits, and is used for the purpose of notifying an end of the message.

In the meantime, a frame stop field 800 may follow the frame end field 700. After the frame stop field 700, the bus line may be recognized as a free state.

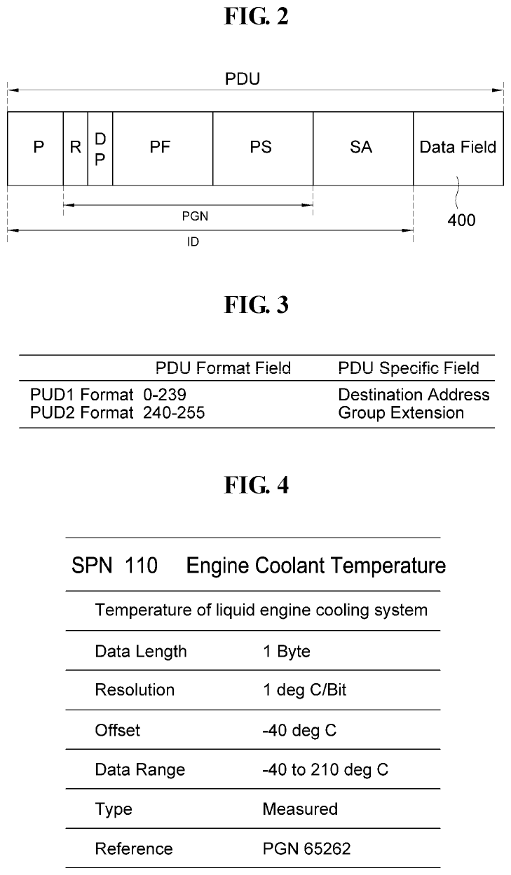

FIG. 2 is a diagram illustrating one exemplary embodiment of a Protocol Data Unit (PDU) in the frame format of FIG. 1, and FIG. 3 is a diagram illustrating a content of a PDU format specific field according to a value of a PDU format field.

Referring to FIG. 2, the PDU may include an identifier ID having a size of 29 bits, and the data field 400. That is, the PDU may be defined with an identifier ID having a size of 29 bits, and the data field 400. Herein, the identifier ID includes the basic identifier 201 and the extended identifier 204.

The identifier ID of the PDU includes a priority field P having a size of 3 bits, a reservation bit R having a size of 1 bit, a data page field DP having a size of 1 bit, a PDU format field PF having a size of 8 bits, a PDU specific field (PS) having a size of 8 bits, and a source address field SA having a size of 8 bits.

The priority field P is used for determining a priority of the message during the mediation processing. The priority field P sets a priority of a message in the network, and makes a message with higher importance be transceived before a message with lower priority. For example, as the value of the priority field P is smaller, the message has higher priority. As a specific example, when the priority field P has a value of “000”, the message including the priority field P with the value of “000” is first processed. However, when the priority field P has a value of “111”, the message including the priority field P with the value of “111” is processed last.

The reservation bit R is reserved for future use. When the message is transmitted, the value of the reservation bit R always needs to be set to “0”.

A data page field DP functions as a page selector for the PDU format field PF. When the value of the data page field DP is “0”, this indicates 0 page. In the meantime, one page is reserved for the future use.

The PDU format field PF may have values of 0 to 255 (for example, 0x00 to 0xFF).

The PDU specific field PS is defined according to the value of the PDU format field PF. For example, when the PDU format field PF has the values of 0 to 239 (0x00 to 0xEF), the PDU specific field PS includes a designation address of a node (that is, a reception node) that receives a message as illustrated in FIG. 3. That is, when the PDU format field PF is defined as a first PDU format field (PDU1 Format) having values of 0 to 239 (for example, 0x00 to 0xEF), the PDU specific field PS defines a destination address of a node (that is, a reception node) that receives a message.

In the meantime, when the PDU format field PF has the values of 240 to 255 (for example, 0xF0 to 0xFF), the PDU specific field PS includes group extension as illustrated in FIG. 3. That is, when the PDU format field PF is defined as a second PDU format field (PDU2 Format) having the values of 240 to 255 (for example, 0xF0 to 0xFF), the PDU specific field PS defines group extension. The group extension provides a large number of setting values for identifying the messages broadcasted to all of the nodes on the network.

The source address field SA indicates an address of a node (for example, a transmitting node) that transmits the message.

In the meantime, the priority field P, the reservation bit R, the data page field DP, the PDU format field PF, and the PDU specific field PS among the six regions included in the identifier ID may be defined with the number of the parameter group PG (PGN). Hereinafter, for convenience of the description, the number of the parameter group is changed and referred to as a parameter group number PGN. Through the parameter group number PGN of the received message, the receiving node may recognize the type of data included in the received message.

The parameter group may be an engine temperature, for example, an engine coolant temperature, a fuel temperature, and an oil temperature. The parameter group PG and the parameter group number PGN are listed in SAE J1939 (approximately, page 300), and are defined in SAE J1939/71. The SAE 1939 includes a document of about 800 pages filled with the parameter group definition and the Suspect Parameter Number (SPN).

FIG. 4 is a diagram for describing an example of information included in the suspect parameter.

A number of the suspect parameter is a number allocated to a specific parameter in one parameter group. Hereinafter, for convenience of the description, the number of the suspect parameter is changed and referred to as a suspect parameter number SPN.

The suspect parameter may include information on a data length (byte), the type of data, resolution, offset, and a range and reference tag (or label) like the example illustrated in FIG. 4.

The plurality of suspect parameters sharing the common characteristics is grouped into one parameter group, and the plurality of suspect parameters grouped into one parameter group is transmitted through the network using the same parameter group number PGN.

The parameter group number PGN 65262 of FIG. 4 may include the plurality of suspect parameters having the common characteristics (that is, the characteristics related to the engine temperature), so that the suspect parameter (that is, SPN 110) having the number of 110 among the plurality of suspect parameters may include information related to the engine coolant temperature. For example, SPN 110 is related to the engine coolant temperature, and the data length, the resolution, the offset, the data range, the type of data, and the reference tag thereof are as shown in FIG. 4.

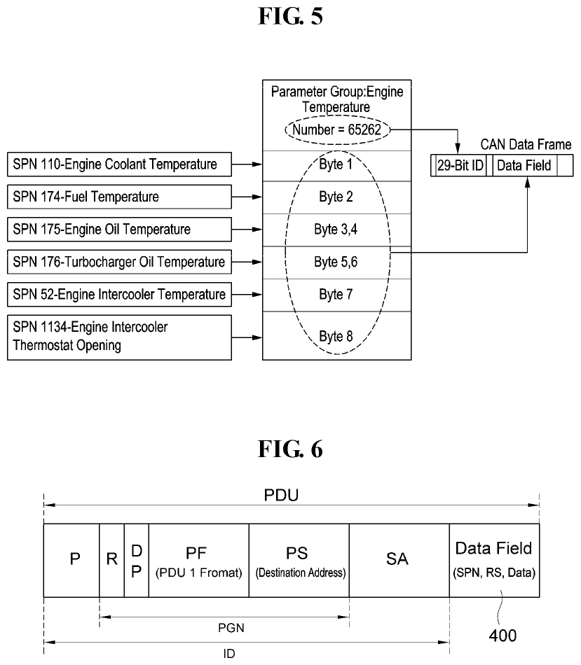

FIG. 5 is a diagram for describing a use example of the suspect parameter number SPN and the parameter group number PGN.

For example, parameter group number (PGN) 65262 may represent data related to the engine temperature like the example illustrated in FIG. 5. All of the suspect parameters of FIG. 5 are logically selected so as to be appropriate for the parameter group related to the engine temperature. The suspect parameters related to the engine temperature may be allocated to parameter group number 65262. That is, PGN 65262 may include the suspect parameters related to the engine temperature.

PGN 65262 may include, for example, 5 suspect parameters. As a particular example, PGN 65262 may include parameters for SPN 110, 174, 175, 176, 52, and 1134. Herein, SPN 110 may include the parameter related to an engine coolant temperature, SPN 174 may include the parameter related to a fuel temperature, SPN 175 may include the parameter related to an engine oil temperature, SPN 176 may include the parameter related to a turbocharger oil temperature, SPN 52 may include the parameter related to an engine intercooler temperature, and SPN 1134 may include the parameter related to an engine intercooler thermostat opening.

The parameter group number PGN is written in the identifier ID of the CAN communication message, and the parameter data corresponding to each of the suspect parameter numbers SPNs included in the parameter group number PGN may be filled in the data field 400 of the CAN communication message.

In the meantime, when the node (for example, the transmitting node) transmits the CAN communication message including the first PDU format field PDU1 Format, data corresponding to any one specific suspect parameter number SPN within the parameter group number PGN may be transmitted to one specific node (for example, the receiving node). That is, the CAN communication message including the first PDU format field PDU1 Format includes the destination address for the data, so that the data may be transmitted to the specific node (for example, the receiving node) corresponding to the destination address.

In the meantime, when the node (for example, the transmitting node) transmits the CAN communication message including the second PDU format field PDU2 Format, all of the data corresponding to all of the suspect parameter numbers SPNs within the parameter group number PGN are broadcasted on the network (or the bus line). That is, the CAN communication message including the second PDU format field PDU2 Format does not include the destination addresses for the data, so that the data are broadcasted on the network.

When the data frame is configured by using the first PDU format field PDU1 Format, the number of data usable in an Original Equipment Manufacturer (OEM) among 240 data (data having a value of 0 to data having a value of 239) of the PDU format field PF is one (for example, data having the value of 239). Further, when the data frame is configured by using the first PDU format field PF, the PDU specific field PS is simply used as the destination address, but is not used as the parameter group number PGN. Accordingly, when the data frame is configured by using the first PDU format field PF, the total number of data usable as the parameter group number PGN is one.

In the meantime, when the message frame is configured by using the second PDU format field PDU2 Format, the number of data usable in the OEM among 16 data (data having the value of 240 to data having the value of 255) of the PDU format field PF is one (for example, data having the value of 255). Further, when the message frame is configured by using the second PDU format field PF, the PDU specific field PS of 8 bits is used as group extension, so that the number of data generable by the PDU specific field PS is 256 (=28). Accordingly, when the data frame is configured by using the second PDU format field PDU2 Format, the number of data calculated according to a combination (1×256) of the number (1) of data usable in the PDU format field PF and the number (256) of data usable in the PDU specific field PS is 256.

Accordingly, the sum of the number (one) of data usable in the case where the data frame is configured by using the first PDU format field PDU1 Format and the number (256) of data usable in the case where the message frame is configured by using the second PDU format field PDU2 Format is 257 (=256+1).

In the meantime, the parameter group number PGN includes the data page field DP of 2 bits, so that the number of data generable by the data page field DP is 2 (=21). Accordingly, the total number of data usable as the parameter group number PGN is 514 (=257×2).

However, as the number of nodes (for example, the electric control units) provided in a construction vehicle recently increases, setting items of each node sharply increase, so that it is difficult to respond to the sharp increase in the setting items with the 514 parameter group numbers PGN. Accordingly, there is inevitably a restriction in the allocation of the parameter group number PGN for the setting items.

When the CAN communication message is transmitted by using the second PDU format field PDU2 Format, one parameter group number PGN includes the plurality of suspect parameter numbers SPNs, so that even when one suspect parameter corresponding to any one setting item is corrected (is setting-changed), other remaining suspect parameters constituting one group (that is, the parameter group) with the one suspect parameter need to be written as existing values. Accordingly, even when only one specific suspect parameter among the suspect parameters in the specific parameter group is corrected, other suspect parameters in the specific parameter group need to be written again, so that there is a high probability that an error will occur.

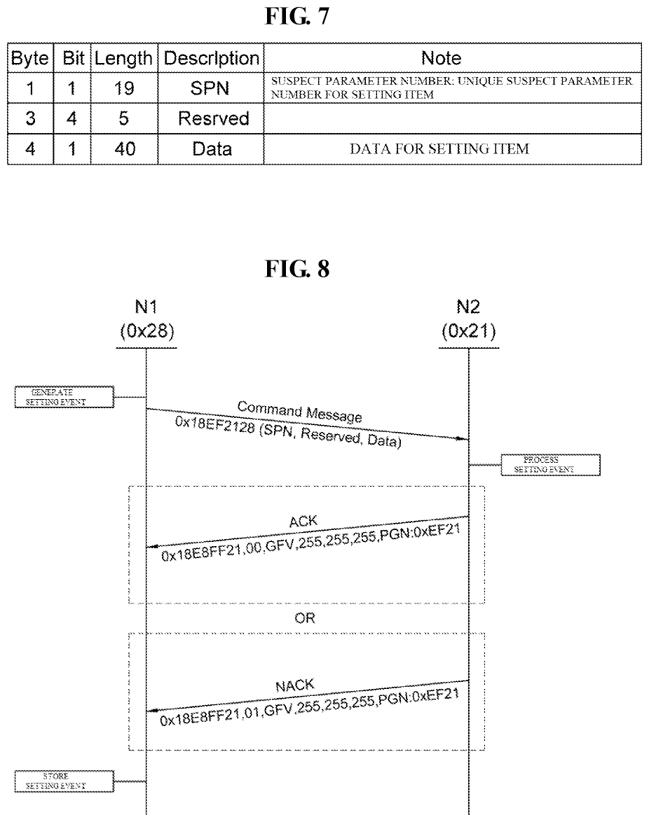

FIG. 6 is a diagram illustrating another exemplary embodiment of the protocol data unit PDU in the frame format of FIG. 1, and FIG. 7 illustrates data included in a data field 400 of FIG. 6.

A protocol data unit PDU according to another exemplary embodiment of the present disclosure includes a first PDU format field PDU1 Format as illustrated in FIG. 6. Accordingly, a PDU specific field PS of the protocol data unit PDU of FIG. 6 includes a destination address.

As illustrated in FIGS. 6 and 7, the data field 400 of the protocol data unit PDU includes a suspect parameter number SPN, a reservation bit RS, and parameter data Data.

The suspect parameter number SPN in one parameter group number PGN may have a size of 19 bits. Accordingly, the number of data (data having a value of 0 to data having a value of 524287) generable by the suspect parameter number SPN is 524288. However, the number of data (for example, data having a value of 516096 to data having a value of 52487) usable in an OEM among the 524288 data is 8192. Accordingly, the 8192 distinguishable suspect parameter numbers SPNs are usable. That is, the fairly large number of 8192 different suspect parameter numbers SPNs may be allocated (or assigned) to the setting items.

In this case, the data field 400 of one message frame includes only one suspect parameter number SPN, not the plurality of suspect parameter numbers SPNs.

In the meantime, the parameter group number PGN may have the value related to the suspect parameter number SPN of the data field 400 thereof. For example, when the suspect parameter number SPN of the data field 400 is 110, the parameter group number PGN may be 63256.

The parameter data Data means actual data. For example, when the suspect parameter number SPN of the data field 400 is 110, the parameter data Data thereof may represent an engine coolant temperature.

A reservation bit RS is reserved for future use.

According to the structure of the protocol data unit PDU illustrated in FIG. 6, only one suspect parameter number SPN is written in the data field 400, so that even when the suspect parameter is corrected (setting-changed), it is not required to write the other remaining suspect parameters constituting one group (that is, the parameter group) with the one suspect parameter. Accordingly, when the setting of the parameter data Data is changed, an error generation probability may be remarkably reduced.

Since the PDU format field PF is set by the first PDU format field PDU1 Format method, it is possible to designate a destination address of a receiving node.

In the meantime, a priority field P, the reservation bit R, and a source address field SA of FIG. 6 are the same as the priority field P, the reservation bit R, and the source address field SA of FIG. 2, so that the descriptions of the priority field P, the reservation bit R, and the source address field SA of FIG. 6 refer to FIG. 2 and the related description.

FIG. 8 is a diagram for describing a method of transmitting a CAN communication message having the data frame structure of FIG. 6.

When an event (that is, a setting event) for setting a parameter for a specific setting item to a specific value is generated, a transmitting node (or an originator node) N1 transmits a command message related to the setting event to a receiving node (or a responder node) N2. In this case, the command message includes the first PDU format field PDU1 Format.

The foregoing setting event may be related to, for example, flow rate setting. In particular, when a size of a minimum flow rate in the flow rate setting is set to 50 [1 pm], suspect parameter number SPN 521188, the reservation bit, and parameter data 50 may be written in the data field 400 of the command message to be transmitted.

In the meantime, when an identifier ID of the command message has a value of 0x18EF2128, “0x18” indicates priority of the message. That is, “0x18” means the value of 6, which means that the priority of the message is sixth. Further, “EF” of the message represents the value of 239, which means that the message includes the first PDU format field PDU1 Format. Further, “21” of the message represents the destination address (that is, the address of the receiving node N2: 0x21), which corresponds to the address (0x21) of the receiving node N2. Further, “28” of the message represents the transmitter address (that is, the address of the transmitting node N1: 0x28), which corresponds to the address (0x28) of the transmitting node N1.

The receiving node N2 processes the event based on the data included in the data field 400 of the received command message.

In the meantime, after the receiving node N2 processes the setting event, the receiving node N2 may or may not transmit a response message related to the processing of the setting event to the transmitting node N1.

After the setting event is processed, information related to the processed setting event may be stored.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting, with the true scope and spirit being indicated by the following claims.

What is claimed is:

1. A data frame structure of a Controller Area Network communication message for construction machinery, the data frame structure comprising:
an identifier including a parameter group number having a destination address; and
a data field including a suspect parameter number related to the parameter group number and parameter data related to the suspect parameter number.

2. The data frame structure of claim 1, wherein the data field further includes a reservation bit.

3. The data frame structure of claim 1, wherein the suspect parameter number has a size of 19 bits.

4. The data frame structure of claim 3, wherein the suspect parameter number is defined by 8192 usable data among 2¹⁹ data.

5. The data frame structure of claim 4, wherein the usable data is the data having a value of 516096 to data having a value of 524287.

6. The data frame structure of claim 1, wherein the parameter group number includes:
a PDU specific field defining the destination address; and
a PDU format field having a data value in a predetermined range so that the PDU specific field has a destination address.

7. The data frame structure of claim 1, wherein the identifier further includes a transmission source address corresponding to the destination address.

8. A method of transmitting a data frame of a Controller Area Network communication message for construction machinery, the method comprising:
generating a setting event for setting a parameter for a specific setting item to a specific value;
transmitting, by a transmitting node, a command message related to the setting event, to a receiving node; and
processing, by the receiving node, the setting event,
wherein the command message includes: an identifier including a parameter group number having an address of the receiving node; and a data field including a suspect parameter number related to the parameter group number and parameter data related to the suspect parameter number.
